(19) United States
(12) Patent Application Publication
(10) Pub. No.: US 2019/0109374 A1
(43) Pub. Date: Apr. 11, 2019

(54) ANTENNA OF AN IMPLANT PROGRAMMING DEVICE AND PROGRAMMING DEVICE

(71) Applicant: BIOTRONIK SE & CO. KG, BERLIN (DE)

(72) Inventors: CHRISTOPH HAMMERSCHMIDT, BERLIN (DE); JULIAN MERLIN, BERLIN (DE); JOAQUIM FREIXAS MONTOLIO, BERLIN (DE); ENRICO STEPHAN, BERLIN (DE); OLIVER KRIPS, BERLIN (DE); ANDREAS FECHNER, BERLIN (DE); PETER GRUND, BERLIN (DE)

(21) Appl. No.: 16/143,594

(22) Filed: Sep. 27, 2018

(30) Foreign Application Priority Data
Oct. 11, 2017 (EP) 17195924.0

(51) Int. Cl. H01Q 1/38; H01Q 1/27

(52) U.S. Cl. CPC H01Q 1/38; H01Q 1/273

(57) ABSTRACT

An antenna of an implant programming device that has a telemetry transmit/receive stage, in particular working in the ULP-AMI band, for wireless communication with an electronic medical implant. The antenna is formed as a conductor track on a stiff planar carrier substrate. The surface area of the carrier substrate is much larger than the surface area covered by the conductor track.

### CROSS-REFERENCE TO RELATED APPLICATION

This application claims the priority, under 35 U.S.C. § 119, of European patent application EP 17195924.0, filed Oct. 11, 2017; the prior application is herewith incorporated by reference in its entirety.

### BACKGROUND OF THE INVENTION

### Field of the Invention

The invention relates to an antenna of an implant programming device that has a telemetry transmit/receive stage, in particular working in the 401-406 MHz (ULP-AMI—ultra low power active medical implant, MICS—medical implant communication system, MEDS—medical data service) band, for wireless communication with an electronic medical implant. It furthermore relates to a corresponding programming device as such.

Electronic medical implants, such as, for example, cardiac pacemakers, implantable defibrillators, cochlear implants, implantable medication-dosing pumps, and neurostimulators, are provided with built-in operating control units and work largely autonomously because of a control program implemented as hardware or stored in a working memory as software. In many designs and areas of application, however, also provided is the use of an external controller or programming device and/or transmission to the outside of signals recorded in the body of the patient, as well as, for example, transmission of the status of the battery charge. Special additional devices, which will be referred to hereinafter as “implant programming devices,” are used for this, although their function is not limited to reprogramming of implants or operating program updates for implants.

Such programming devices are normally temporarily connected to the electronic medical implant via a so-called telemetry transmission segment, that is, a short-range wireless signal transmission segment, based on amplitude or frequency modulated electromagnetic waves.

It is understood that a radio antenna is required for such signal transmission. The radio antenna is normally built into the programming device and, in known programming devices, takes the form of curved wires that are mechanically fixed via fastening boards and screw connections and are connected especially to an antipole (for instance, an EMC shroud, EMC—electromagnetic compatibility). They may then be affixed in the device housing by clamping.

Certain drawbacks have been found in known antenna designs. Wire antennas are very sensitive to mechanical deformations. The distance between the EMC shroud of the programming device housing and the open antenna end may deviate from the defined spacing. This may detune the antenna from the transmit/receive band. This leads directly to deterioration of the signal quality of the wireless connection to the implant.

### SUMMARY OF THE INVENTION

One object is to provide an antenna of the type according to the category that is improved especially with respect to its sensitivity to mechanical influences. A correspondingly improved programming device is also to be provided.

With the above and other objects in view there is provided, in accordance with the invention, an antenna of an implant programming device for wireless communication with an electronic medical implant, in particular for communication in the 401-406 MHz band. The antenna comprises:

a stiff planar carrier substrate having a surface area; and

a conductor track formed on said carrier substrate and covering a given surface area;

said surface area of said carrier substrate being larger by a multiple than said given surface area covered by said conductor track.

In other words, the invention includes the concept of intentionally shifting away from the conventional antenna structure made of self-supporting conductive wires. It furthermore includes the provision of a planar carrier substrate for the antenna, and finally the idea of embodying the actual antenna as conductor track on such a substrate. In the interest of high mechanical insensitivity, the carrier substrate is essentially stiff and its surface area is much larger than the surface area covered by the conductor track.

In one embodiment, the carrier substrate comprises a printed circuit board material or is made of a printed circuit board material. It may in particular comprise or be made of an epoxy resin-fiber glass fabric composite material, in particular of the FR4 type. FR4 is a NEMA (NEMA—National Electrical Manufacturers Association) grade designation for glass-reinforced epoxy laminate material. FR4 is a composite material composed of woven fiberglass cloth with an epoxy resin binder that is flame resistant (self-extinguishing). Alternatively, it may comprise or be made of a material based on hard paper, in particular of the FR2 type. FR2 (Flame Resistant 2) is a NEMA designation for synthetic resin bonded paper, a composite material made of paper impregnated with a plasticized phenol formaldehyde resin, e.g., used in the manufacture of printed circuit boards.

It is furthermore provided that the carrier substrate may comprise or may be made of a ceramic. The ceramic may comprise aluminum oxide, aluminum nitrite, or LTCC (LTCC—low temperature co-fired ceramics). In another embodiment, the carrier substrate comprises or is made of a PTFE material (PTFE—polytetrafluoroethylene).

In another embodiment, a recess or local thinning in the carrier substrate is provided adjacent to a segment of the conductor track. This embodiment minimizes in particular possible limitations to the antenna properties due to the carrier material. The recess or local thinning is provided in particular near the free end of the conductor track.

In another embodiment of the invention, the antenna is provided with adaptation means for adapting to the telemetry transmit/receive stage or its antenna connector, which adaptation means are integrated on the carrier substrate. This simplifies the production of the overall subassembly made of antenna and adaptation means and contributes to lower production costs.

In a currently advantageous geometric embodiment, the conductor track is embodied curved on a correspondingly curved outer edge of an essentially L-shaped carrier substrate.

Other features which are considered as characteristic for the invention are set forth in the appended claims.

Although the invention is illustrated and described herein as embodied in an antenna of an implant programming device and programming device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic sketch drawing of a first exemplary embodiment of the invention;

FIG. 2 is a diagrammatic sketch drawing of another exemplary embodiment of the invention;

FIG. 3 is a diagrammatic sketch drawing of another exemplary embodiment of the invention; and,

FIG. 4 is a top view of another inventive antenna in a special geometric configuration.

### DETAILED DESCRIPTION OF THE INVENTION

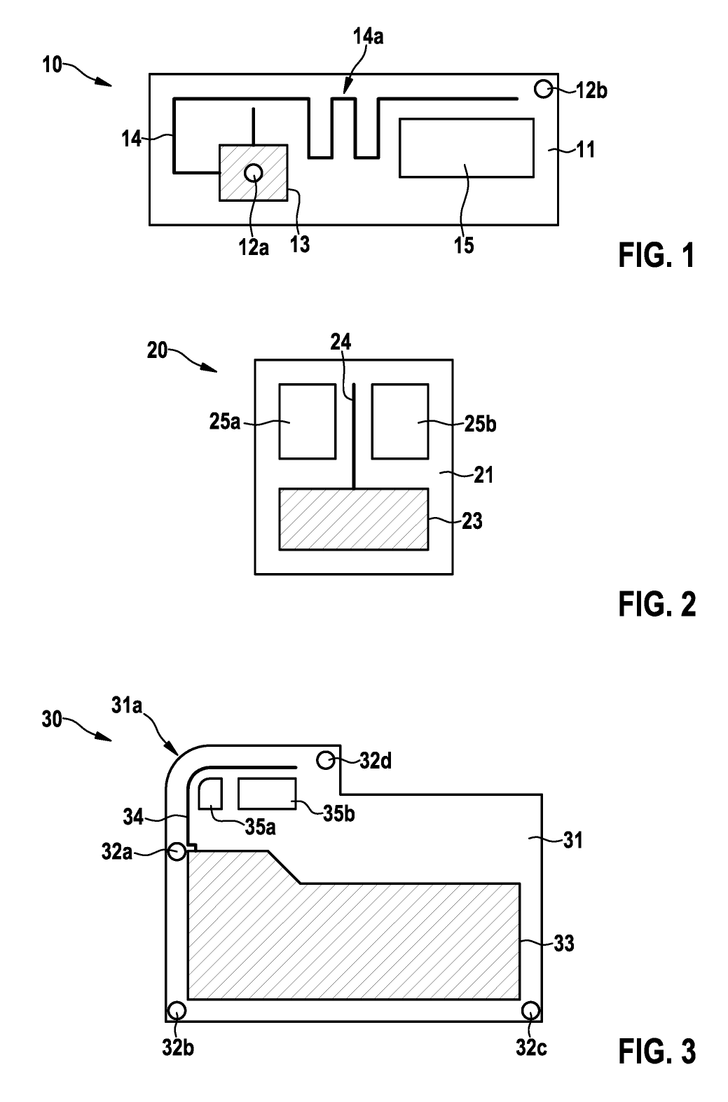

Referring now to the figures of the drawing in detail and first, particularly, to FIG. 1 thereof, there is shown an antenna unit 10 that may be used, for example, in a programming device of a cardiac pacemaker. The antenna unit comprises a printed circuit board 11, configured in a rectangle, that has two bores 12a and 12b for mechanical fastening in the programming device. The surface near the bore 12a is metalized as a connecting region 13, but may also be embodied as a ground plane, while the antenna structure 14 is supplied with power via printed conductive structures and, where necessary, via an adaptation network with electronic components for impedance adaptation using an antenna socket (not illustrated).

An elongated conductor track 14 that forms the actual antenna proceeds from the connecting region 13. The conductor track 14 is bent numerous times and has a meandering center region 14a in order to attain overall a conductor track length for reaching a desired impedance. Provided in the printed circuit board 11 near the free end of the antenna conductor track 14 is a rectangular recess 15 that is added for reducing the influence of the printed circuit board material on the properties of the antenna 14.

FIG. 2 depicts, as another embodiment, an antenna subassembly 20 that is implemented on a square ceramic carrier substrate 21. In this case, proceeding from a ground plane 23 is a relatively short, straight antenna 24 that itself is realized as a conductive coating on the carrier substrate 21. Power may be supplied to the antenna via conductor structures in the ground plane 23 that may also contain components for adapting. Recesses 25a, 25b are provided on both sides of the antenna 24 in the carrier substrate for improving the properties of the antenna. In this case, as well, the connecting surface 23 may be replaced by an electronic subassembly with further functions or combined with such a subassembly.

FIG. 3 depicts, as another exemplary embodiment, an antenna subassembly 30 that is in principle constructed similar to the antenna subassemblies 10 and 20 according to FIGS. 1 and 2, but that has a different geometric configuration. The subassembly in this case comprises a largely rectangular carrier substrate 31 that is provided, however with a projection 31a on one long side. In addition, one corner of the carrier substrate 31 is embodied rounded in the region of the projection 31a.

At that location, and along the outer edge of the projection 31a, an evenly curved conductor track 34 runs as the actual antenna of the subassembly. Again, two recesses 35, 35b for reducing the influence of the printed circuit board material on the properties of the antenna 34 are provided near the conductor track. In addition, the relatively large carrier substrate 31 has a total of four fastening bores 32a-32d, of which one, specifically the bore 32a, is placed near the connecting point of the antenna 34 of a connecting metallization 33.

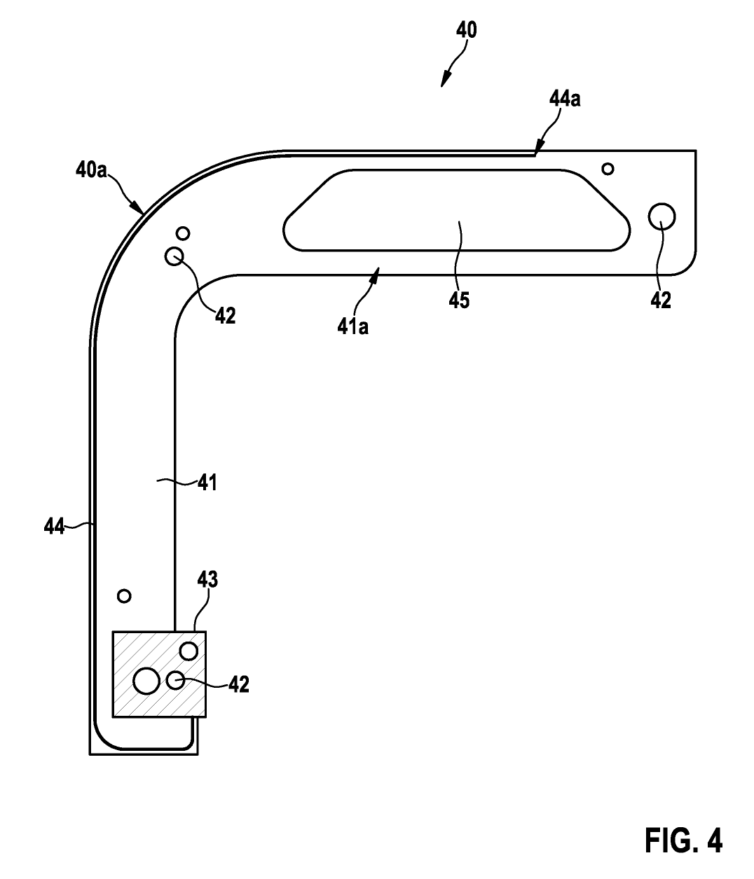

FIG. 4 depicts, as another exemplary embodiment, an antenna subassembly 40 that is substantially configured in an L-shape. The carrier substrate 41 of this exemplary embodiment again comprises a conventional printed circuit board material. In this antenna subassembly, as well, a corner region 40a is curved, especially as an arc of a circle. An antenna power supply point 43 is provided near the lower end of the vertical leg. Also disposed here are a plurality of fastening and adjusting bores 42, which are labeled 42, as are the other fastening adjusting bores at other locations of the antenna subassembly 40.

In this case, as well, an elongated conductor track 44, here bent in two, that forms the actual antenna of the subassembly proceeds from the antenna power supply point 43. This conductor track runs near the arcuate outer edge of the carrier substrate 41 and terminates at a point 44a with some clearance from the free end of the second leg of the “L” (the horizontal leg, in the figure). A recess 45, or cutthrough or thinning, is again provided in the carrier substrate in the end region of the antenna 44. The carrier plate material remaining under the recess acts as a support or stiffening bar 41a for the carrier substrate 41.

It will be understood that, in general, the concepts of the invention may also be executed with a great number of modifications to the examples illustrated here and aspects of the invention stressed above.

1. An antenna of an implant programming device for wireless communication with an electronic medical implant, the antenna comprising:
a stiff planar carrier substrate having a surface area; and
a conductor track formed on said carrier substrate and covering a given surface area;
said surface area of said carrier substrate being larger by a multiple than said given surface area covered by said conductor track.

2. The antenna according to claim 1, wherein said carrier substrate is made of printed circuit board material.

3. The antenna according to claim 2, wherein said carrier substrate is made of an epoxy resin-fiber glass fabric composite material.

4. The antenna according to claim 3, wherein said carrier substrate is made of FR4 type material.

5. The antenna according to claim 2, wherein said carrier substrate is made of a material based on hard paper.

6. The antenna according to claim 5, wherein said carrier substrate is made of FR2 type material.

7. The antenna according to claim 1, wherein said carrier substrate is made of a ceramic.

8. The antenna according to claim 7, wherein said ceramic comprises a material selected from the group consisting of aluminum oxide, aluminum nitrite, and low-temperature co-fired ceramics (LTCC).

9. The antenna according to claim 1, wherein said carrier substrate is made of polytetrafluoroethylene (PTFE).

10. The antenna according to claim 1, wherein said carrier substrate is formed with at least one recess or local thinning adjacent a segment of said conductor track.

11. The antenna according to claim 10, wherein said recess or local thinning is formed near a free end of said conductor track.

12. The antenna according to claim 1, comprising adaptation means for adapting to a telemetry transmit/receive stage or an antenna connector thereof, said adaptation means being integrated on said carrier substrate.

13. The antenna according to claim 1, wherein said carrier substrate is substantially L-shaped and having a curved outer edge, and said conductor track is curved along said curved outer edge of said carrier substrate.

14. The antenna according to claim 1, configured for wireless communication in the 401-406 MHz band.

15. A programming device of an electronic medical implant, comprising an antenna according to claim 1.

16. The programming device according to claim 15, configured for a cardiac pacemaker, a defibrillator, or a neurostimulator.
